(19) United States
(12) Patent Application Publication
(10) Pub. No.: US 2020/0220126 A1
(43) Pub. Date: Jul. 9, 2020

(54) ELECTRICITY STORAGE MODULE AND MANUFACTURING METHOD OF ELECTRICITY STORAGE MODULE

(71) Applicant: Honda Motor Co.,Ltd., Tokyo (JP)

(72) Inventor: Atsushi SAKURAI, Saitama (JP)

(73) Assignee: Honda Motor Co.,Ltd., Tokyo (JP)

(21) Appl. No.: 16/601,596

(22) Filed: Oct. 15, 2019

(30) Foreign Application Priority Data
Oct. 18, 2018 (JP) 2018-196888

(51) Int. Cl. H01M 2/10; H01M 2/20; H01M 2/26; H01M 2/30; H01M 10/647; H01M 10/6555; H01M 10/04

(52) U.S. Cl. CPC H01M 2/1077; H01M 2/202; H01M 2/26; H01M 10/0468; H01M 10/647; H01M 10/6555; H01M 10/0481; H01M 2/30

(57) ABSTRACT

The electricity storage module is an electricity storage module in which a plurality of electricity storage cells is accommodated in a cell accommodating body. Inside the cell accommodating body, a plurality of cell accommodating spaces having parallel wall surfaces is arranged in a straight line in an aligning direction of the parallel wall surfaces. In the cell accommodating space, a sheet-like pressing member which gives pressing forces to the electricity storage cells toward the wall surfaces and is accommodated together with the electricity storage cells, and the electricity storage cells is disposed between the pressing member and the wall surfaces.

### CROSS REFERENCE TO RELATED APPLICATIONS

This application claims the priority benefit of Japanese Patent Application No. 2018-196888, filed on Oct. 18, 2018. The entirety of the above-mentioned patent application is hereby incorporated by reference herein and made a part of this specification.

### BACKGROUND OF THE INVENTION

### Technical Field

The disclosure relates to an electricity storage module and a manufacturing method of electricity storage module.

### Related Art

An electricity storage module mounted on a hybrid car, an electric car or the like is configured by laminating a plurality of electricity storage cells. As for the electricity storage cell, in addition to the electricity storage cell which is configured by containing a battery element consisting of a positive electrode and a negative electrode inside a cell can made of metal, there is the electricity storage cell which is configured by enclosing a battery element in laminate films made of resin. The electricity storage cell has a pair of positive electrode terminal and negative electrode terminal outside the electricity storage cell, and the electrode terminals of adjoining electricity storage cells are electrically connected in series or in parallel by a bus bar.

The electricity storage module mounted on vehicle receives vibration during running and the like and the electricity storage cells rattle, resulting in a risk that the reliability of the electrical connection between the electricity storage cells with each other or between the electricity storage cells and the outside is damaged. Therefore, conventionally, there are electricity storage modules in which elastic spacers are inserted between adjoining electricity storage cells and a plurality of laminated electricity storage cells are held without rattling (for example, see patent literature 1 (Japanese Laid-Open No. 2012-22937)).

However, when an acceleration caused by a collision load or the like is input to the electricity storage module in a lamination direction of the electricity storage cells, the elastic spacer is crushed by the load, and thus all the electricity storage cells move along an input direction of the acceleration. A moving amount of the electricity storage cells at this time is larger for the electricity storage cells disposed closer to an input side of the acceleration. As a result, there are problems that positions of connection sections of the electrode terminals of the electricity storage cells and the bus bar, a harness or the like relatively experience a relatively large change, great load is applied to the connection sections and the reliability of the electrical connection decreases. Besides, the electricity storage cell disposed on the opposite side of the input side of the acceleration receives the load of all the other electricity storage cells disposed nearer to the input side of the acceleration, and thus there is also a risk that the electricity storage cell itself is damaged.

### SUMMARY

(1) The electricity storage module of the disclosure is an electricity storage module (for example, an electricity storage module 1, 1A described later) in which a plurality of electricity storage cells (for example, electricity storage cells 3 described later) is accommodated in a cell accommodating body (for example, a cell accommodating body 2 described later); wherein, inside the cell accommodating body, a plurality of cell accommodating spaces (for example, cell accommodating spaces 27 described later) having parallel wall surfaces (for example, wall surfaces 23a, 26a described later) is arranged in a straight line in an aligning direction of the parallel wall surfaces; in the cell accommodating space, a sheet-like pressing member (for example, pressing member 4 described later) which gives pressing forces to the electricity storage cells toward the wall surfaces and is accommodated together with the electricity storage cells, and the electricity storage cells are disposed between the pressing member and the wall surfaces.

(12) The manufacturing method of electricity storage module of the disclosure is the manufacturing method of an electricity storage module (for example, an electricity storage module 1, 1A described later) in which a plurality of electricity storage cells (for example, electricity storage cells 3 described later) is accommodated in a cell accommodating body (for example, a cell accommodating body 2 described later); wherein, inside the cell accommodating body, a plurality of cell accommodating spaces (for example, cell accommodating spaces 27 described later) having parallel wall surfaces (for example, wall surfaces 23a, 26a described later) are arranged in a straight line in an aligning direction of the parallel wall surfaces; the electricity storage cells and a sheet-like pressing member (for example, a pressing member 4 described later) which gives the electricity storage cells pressing forces toward the wall surfaces are laminated and accommodated in the cell accommodating spaces, and the electricity storage cells are pressed to the wall surfaces by expansion of the pressing member.

### BRIEF DESCRIPTION OF THE DRAWINGS

FIG. 1 is a perspective view of an electricity storage module of an embodiment of the disclosure.

FIG. 2 is a cross-section view in which the electricity storage module shown in FIG. 1 is cut off along an A-A line.

FIG. 3 is a side view showing only a cell accommodating body of the electricity storage module shown in FIG. 1.

FIG. 4 is a diagram illustrating a situation that the electricity storage cells are accommodated in cell accommodating spaces of the electricity storage module shown in FIG. 1.

FIG. 5 is a cross-section view showing an example of a pressing member covered by a resin film.

FIG. 6 is a diagram illustrating the effect of the electricity storage module of the disclosure.

FIG. 7 is a cross-section view showing a state that a temperature adjustment device and a temperature measurement device are mounted on the electricity storage module shown in FIG. 1.

FIG. 8 is a perspective view showing an electricity storage module of another embodiment of the disclosure.

FIG. 9 is a cross-section view in which the electricity storage module shown in FIG. 8 is cut off along a B-B line.

FIG. 10 is a diagram illustrating a situation that the electricity storage cells are accommodated in cell accommodating spaces of the electricity storage module shown in FIG. 8.

FIG. 11 is a front view showing another example of a pressing member.

FIG. 12 is a diagram illustrating a situation that the pressing member shown in FIG. 11 is used to accommodate the electricity storage cells in the cell accommodating spaces.

### DESCRIPTION OF THE EMBODIMENTS

In the following, embodiments of the disclosure are described in detail with reference to the drawings.

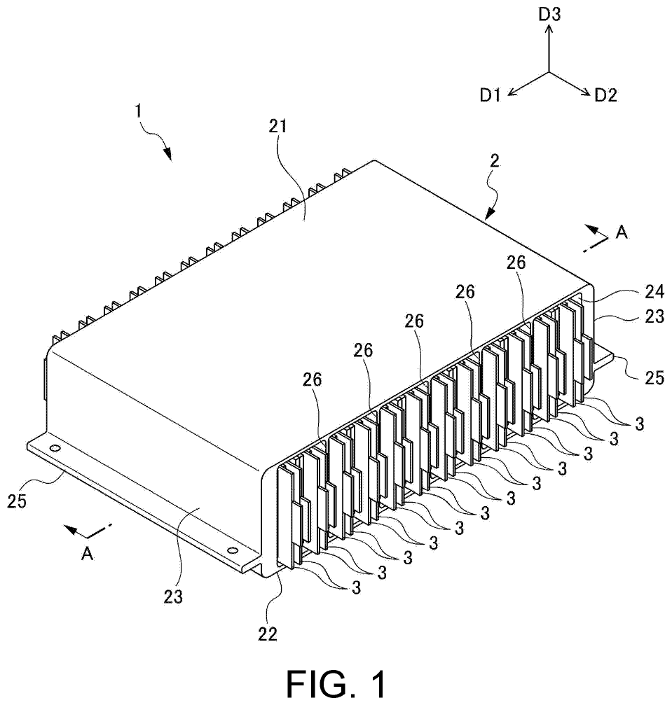

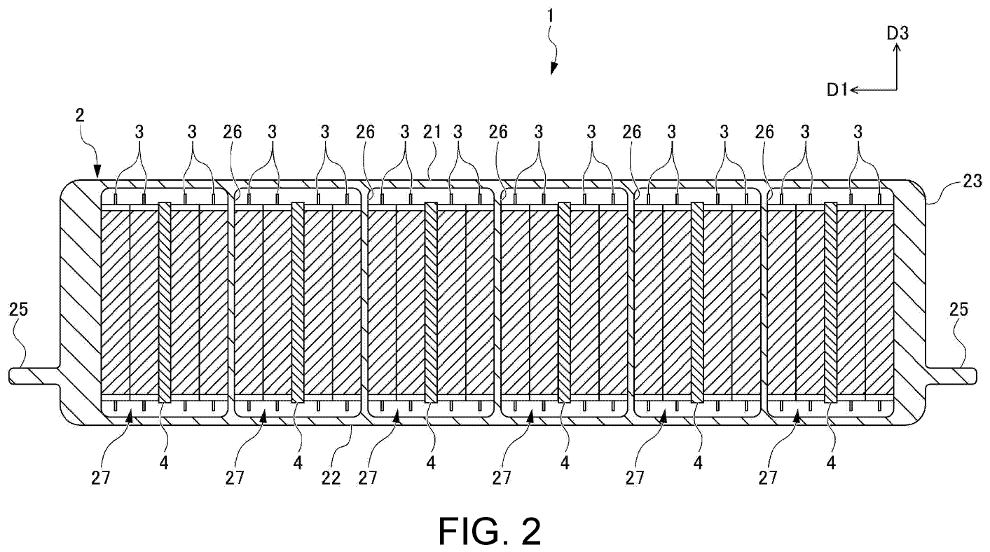

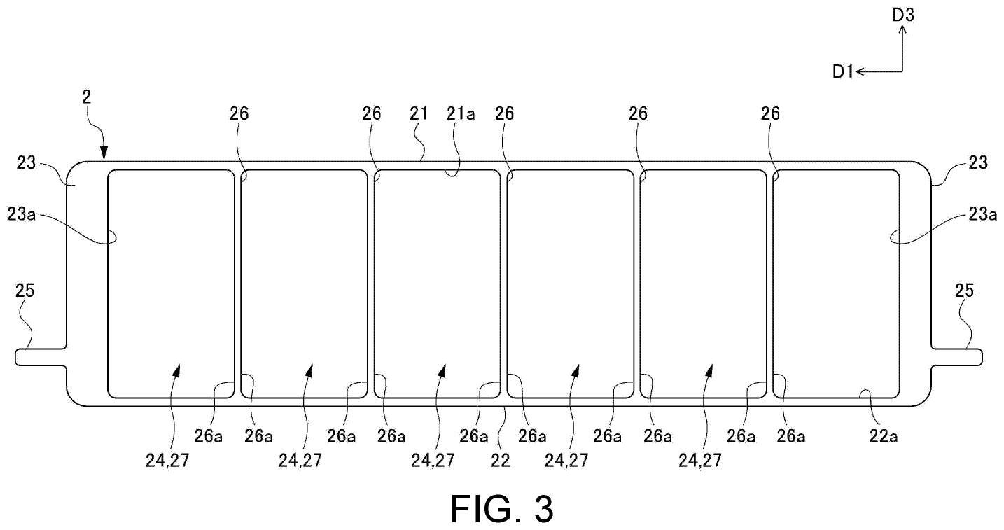

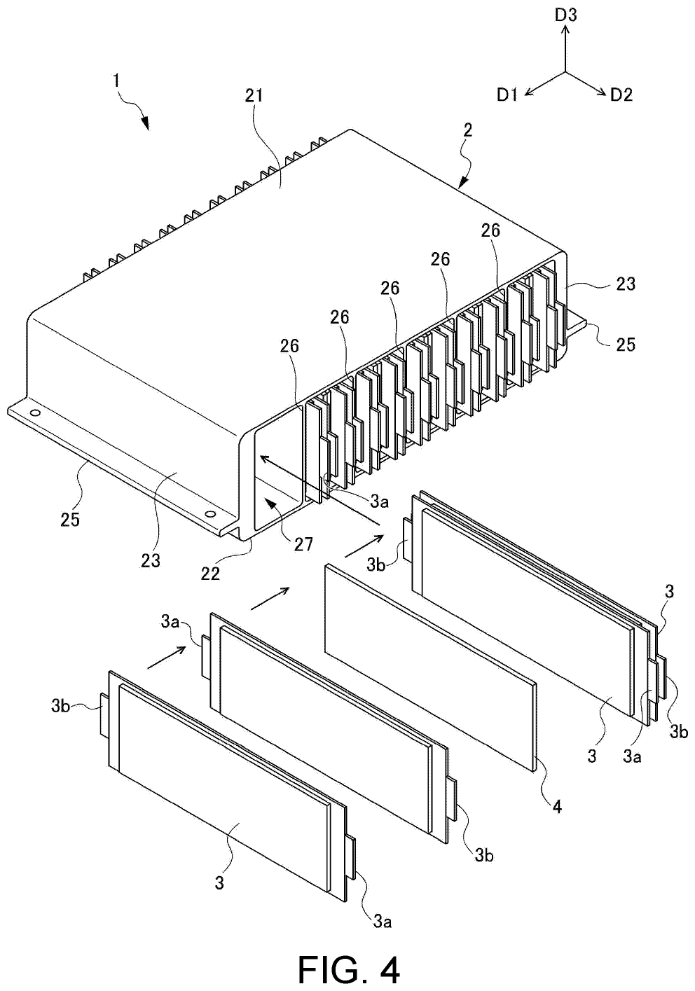

FIG. 1 is a perspective view showing an electricity storage module of an embodiment of the disclosure. FIG. 2 is a cross-section view in which the electricity storage module shown in FIG. 1 is cut off along an A-A line. FIG. 3 is a side view showing only a cell accommodating body of the electricity storage module shown in FIG. 1. FIG. 4 is a diagram showing a situation that the electricity storage cells are accommodated in cell accommodating spaces of the electricity storage module shown in FIG. 1.

An electricity storage module 1 shown in this embodiment has a cell accommodating body 2, a plurality of electricity storage cells 3 accommodated in the cell accommodating body 2, and a plurality of pressing members 4 accommodated in the cell accommodating body 2 together with the electricity storage cells 3. Moreover, in directions shown in each diagram, a direction D1 indicates a length direction of the cell accommodating body 2. A direction D2 indicates a width direction of the cell accommodating body 2. A direction D3 indicates a height direction of the cell accommodating body 2. The direction shown by the direction D3 is the upward direction along the gravity direction.

The cell accommodating body 2 is formed into a shape of square tube that has a rectangular top board 21 and a rectangular bottom board 22 being long in the direction D1, side boards 23, 23 being disposed on two ends in the direction D1 and joining the top board 21 and the bottom board 22, and rectangular opening portions 24, 24 opening on two side surfaces in the direction D2. The side board 23 integrally has a plate-like flange portion 25 overhanging across the entire length of the width direction along the direction D1. The flange portion 25 is disposed in parallel with the top board 21 and the bottom board 22.

There is a plurality (five piece in this embodiment) of partition plates 26 inside the cell accommodating body 2. Each partition plate 26 is disposed at an equal interval between the two side boards 23, 23 and is integrally arranged across a wall surface 21a on an internal side of the top board 21 and a wall surface 22a on an internal side of the bottom board 22. Wall surfaces 26a of all the partition plates 26 are in parallel with each other. In addition, the wall surfaces 26a of the partition plates 26 and the wall surface 23a on the internal side of the side board 23 are in parallel with each other. Accordingly, inside the cell accommodating body 2, the cell accommodating spaces 27 capable of accommodating the electricity storage cells 3 are separated between the parallel wall surfaces 26a, 26a of two pieces of adjoining partition plates 26, 26 and between the wall surface 23a of the side board 23 and the wall surface 26a of the partition plate 26.

The cell accommodating body 2 in this embodiment has six cell accommodating spaces 27 separated by five pieces of the partition plates 26. The six cell accommodating spaces 27 are arranged in a straight line along the aligning direction (the direction D1) of the wall surfaces 26a of the partition plates 26 and the wall surface 23a of the side board 23. Moreover, the partition plates 26 extend across the entire length of the cell accommodating body 2 in the direction D2. Therefore, the opening portions 24, 24 on two side surfaces of the cell accommodating body 2 are also opening portions on two side surfaces of each cell accommodating space 27.

The top board 21, the bottom board 22, the side board 23, the flange portion 25 and the partition plates 26 of the cell accommodating body 2 are all formed by a metal material having good heat conductivity, such as aluminum, aluminum alloys or the like. The cell accommodating body 2 has the same shape along the direction D2, and thus can be an integrally molded article which is impact molded or extrusion molded along the direction D2. Accordingly, strength and heat-transfer performance of the cell accommodating body 2 can be improved. In addition, because there is no need to assemble each component formed independently, the component number can be reduced and cost reduction can be achieved.

The electricity storage cell 3 contains therein a battery element (not shown) that has a positive electrode plate and a negative electrode plate. The electricity storage cell 3 is flat in the direction D1 as shown in FIG. 4, and resembles a shape of a horizontally long rectangle that has a height slightly lower than the height of the cell accommodating space 27 and has a width slightly wider than the width of the cell accommodating space 27. A positive electrode terminal 3a electrically connected to the positive electrode plate of the battery element is arranged in a protruding condition at one end of the electricity storage cell 3 in the width direction (the direction D2), and a negative electrode terminal 3b electrically connected to the negative electrode plate of the battery element is arranged in a protruding condition at the other end.

The electricity storage cell 3 shown in this embodiment has a shape of a laminated pack in which the battery element is enclosed in a laminate film, but the electricity storage cell of the disclosure is not limited hereto and may be an electricity storage cell in which the battery element is contained in a cell can made of metal. In addition, the electricity storage cell 3 may contain the battery element together with an electrolytic solution or may contain a battery element consisting of all-solid-state battery not having an electrolytic solution.

Four electricity storage cells 3 are accommodated in one cell accommodating space 27 by disposing the electricity storage cells 3 in a manner that the positive electrode terminals 3a and the negative electrode terminals 3b turn sideways (a direction along the direction D2) and inserting the electricity storage cells 3 from the opening portion 24. Accordingly, a total of 24 electricity storage cells 3 is dispersed and accommodated in six cell accommodating spaces 27 in the cell accommodating body 2.

The positive electrode terminals 3a of the electricity storage cells 3 in the cell accommodating spaces 27 are disposed on one of the opening portions 24, 24 on two side surfaces, and the negative electrode terminals 3b are disposed on the other of the opening portions 24, 24. The positive electrode terminal 3a and the negative electrode terminal 3b of each electricity storage cell 3 protrude from the opening portions 24 toward the lateral side of the cell accommodating body 2. Accordingly, the electrical extraction direction of the electricity storage cells 3 is along the direction D2, and as described later, the pressing direction of the pressing members 4 to the electricity storage cells 3 (a direction along the direction D1) is a different direction. Therefore, miniaturization and weight reduction of the cell accommodating body 2 can be achieved, and the assembly activity of the electricity storage module 1 is also improved. In addition, because the positive electrode terminals 3a and the negative electrode terminals 3b of the electricity storage cells 3 are disposed apart, the current distribution of the electricity storage cells 3 is equalized and performance deterioration of the electricity storage cells 3 can also be suppressed.

In this embodiment, orientations of the positive electrode terminals 3a and the negative electrode terminals 3b of adjoining electricity storage cells 3, 3 are disposed to be opposite directions. Therefore, the positive electrode terminals 3a and the negative electrode terminals 3b protruding from the opening portions 24 on the side surfaces of the cell accommodating body 2 are arranged alternately along the direction D1 of the cell accommodating body 2. The positive electrode terminals 3a and the negative electrode terminals 3b of adjoining electricity storage cells 3, 3 are electrically connected by a bus bar not shown. In addition, the positive electrode terminals 3a or the negative electrode terminals 3b of the electricity storage cells 3, 3 disposed on two ends are electrically connected to an external machine by a harness not shown. Moreover, in this embodiment, all the electricity storage cells 3 in the cell accommodating body 2 are connected in series by a bus bar, but all the electricity storage cells 3 in the cell accommodating body 2 may also be connected in parallel by aligning the orientations of the positive electrode terminals 3a and the negative electrode terminals 3b of the electricity storage cells 3.

The pressing members 4 are formed into a shape of rectangular sheet the same as the electricity storage cells 3 and one piece of the pressing member 4 is accommodated in each cell accommodating space 27. As shown in FIG. 4, the pressing members 4 are inserted from the opening portions 24 into the cell accommodating spaces 27 and accommodated in the cell accommodating spaces 27 in the state of being laminated with the electricity storage cells 3. In this embodiment, the pressing member 4 is sandwiched between the two electricity storage cells 3, 3 in the middle of the four electricity storage cells 3 in each cell accommodating space 27 in a manner of separating each two electricity storage cells 3, 3 of the four.

The pressing member 4 gives pressing forces toward the wall surface 26a of the partition plate 26 or the wall surface 23a of the side board 23 to the four electricity storage cells 3 accommodated in the same cell accommodating space 27 as the pressing member 4. That is, the pressing member 4 presses each two electricity storage cells 3 disposed on two sides of the pressing member 4 by a predetermined pressing force toward the wall surface 26a of the partition plate 26 or the wall surface 23a of the side board 23 which is disposed on the opposite side of the pressing member 4. Accordingly, each four electricity storage cells 3 in each cell accommodating space 27 is held without rattling in each cell accommodating space 27. In addition, the electricity storage cells 3 are uniformly pressed by the sheet-like pressing member 4 to the wall surface 26a of the partition plates 26 or the wall surface 23a of the side board 23, and thereby the contact thermal resistance of the electricity storage cells 3 and the wall surfaces 23a, 26a is reduced, and the temperature rise of the electricity storage cells 3 is suppressed.

There is no limitation on a specific pressing member 4 as long as the pressing member 4 is a member that is easily compressed, capable of exerting a pressing force to the degree that the electricity storage cells 3 in the cell accommodating spaces 27 can be held without rattling, and capable of being formed into a shape of sheet; however, preferably, the pressing member 4 includes an elastic body or a structure having swellability. When the electricity storage cells 3 in the cell accommodating spaces 27 expand due to charge and discharge, the pressing member 4 that contains an elastic body a structure having swellability can absorb the expansion force by compressing. Therefore, the load to the wall surface 26a of each partition plate 26 or the wall surface 23a of the side board 23 or the load to the cell accommodating body 2 during the expansion of the electricity storage cells 3 can be reduced. In addition, during the expansion of the electricity storage cells 3, pressing load is counteracted, the strength and the rigidity of the wall surface 26a of the partition plate 26 or the wall surface 23a of the side board 23 can also be set to be small, and thus the weight reduction and the cost reduction of the electricity storage module 1 can be achieved.

A foam body of rubber of resin can be used as the elastic body. The foam body can easily adjust the pressing force to the electricity storage cells 3 and the absorption situation of the expansion force of the electricity storage cells 3 by appropriately setting a foaming ratio. In addition, by using the foam body, further weight reduction and cost reduction of the electricity storage module 1 can also be achieved.

A swellable resin or resin fiber aggregate that swells by being impregnated with a liquid can be used as a structure having swellability. The specific swellability resin may include a PVDF (polyvinylidene fluoride) or silicone resin. In addition, the specific resin fiber aggregate may include a laminated body of a non-woven fabric of polyolefin resin fiber or phenol resin fiber. The structure having swellability can easily adjust the pressing force to the electricity storage cells 3 and the absorption situation of the expansion force of the electricity storage cells 3 by appropriately adjusting the density, type, diameter, length, and shape of a resin or resin fiber. In addition, in a case that the structure having swellability is used, similar to the case of the foam body, further weight reduction and cost reduction of the electricity storage module 1 can also be achieved.

The pressing member 4 may also press the electricity storage cells 3 to the wall surface 26a of the partition plate 26 or the wall surface 23a of the side board 23 to hold the electricity storage cells 3 by expanding in the thickness direction (the direction D1) inside the cell accommodating space 27 after being laminated with the electricity storage cells 3 and accommodated in the cell accommodating space 27. Accordingly, the electricity storage cells 3 in the cell accommodating space 27 can be held reliably without rattling. Because the pressing member 4 does not hold the electricity storage cells 3 by adhering the electricity storage cells 3 using an adhesion, disassembly becomes easy and recyclability is improved.

In addition, because the pressing member 4 of this embodiment is sandwiched between two electricity storage cells 3, 3, the two parallel wall surface 26a and wall surface 26a that separate the cell accommodating space 27 or the wall surface 26a and the wall surface 23a can be respectively used as heat transfer surfaces. Accordingly, the temperature rise of the electricity storage cells 3 can be further suppressed.

When the pressing member 4 is laminated with the electricity storage cells 3 and accommodated in the cell accommodating space 27, the pressing member 4 may be accommodated in the cell accommodating space 27 in a state of being compressed and be made to expand in the cell accommodating space 27 by a restoring force from the compressed state. Accordingly, the electricity storage cells 3 can be easily inserted into the cell accommodating space 27, and thus the assembly of the electricity storage module 1 is easy.

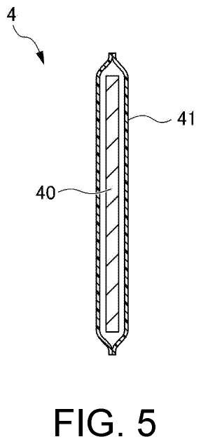

The pressing member 4 may be covered by a resin film 41 as shown in FIG. 5. That is, in a case that the pressing member 4 includes an elastic body 40 for example, the resin film 41 enclose the elastic body 40 in the film by covering the elastic body 40. The resin film 41 can use a soft resin film such as common polypropylene and the like. In a case that the pressing member 4 includes a structure having swellability, there is no need to impregnate the pressing member 4 with a liquid in the cell accommodating space 27, and the liquid can be impregnated in the resin film 41.

By using the pressing member 4 that is covered by the resin film 41 in this way, the pressing member 4 can be used as an insulator. In particular, when the electricity storage cells 3 use cell cans made of metal, because the pressing member 4 can be used instead of an insulation spacer, the number of insulation spacers can be reduced. In addition, this type of pressing member 4 can also be used as the insulator during the electrical connection of adjoining electricity storage cells 3, 3 between which the pressing member 4 is sandwiched.

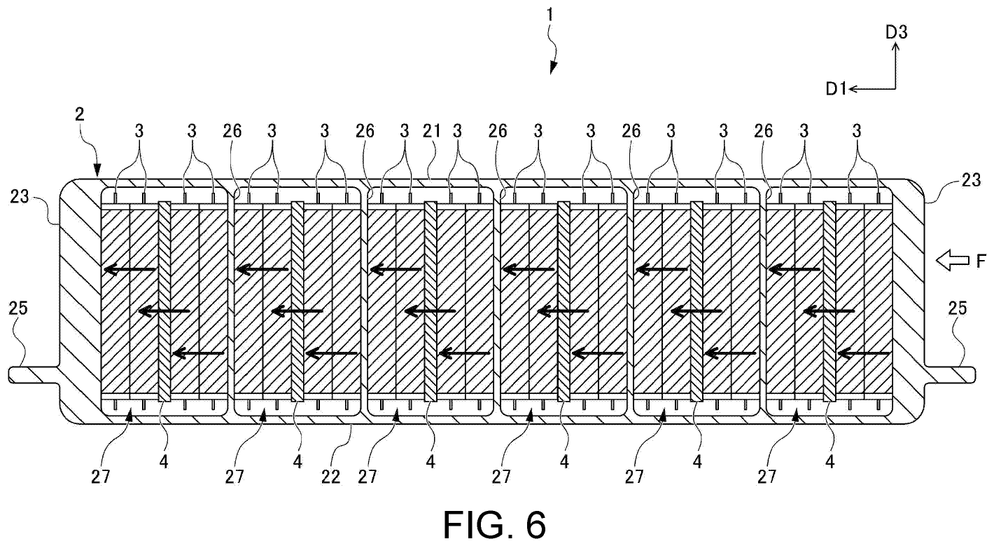

Here, FIG. 6 is used to describe the unique effect of the case that 24 electricity storage cells 3 in the cell accommodating body 2 are dispersed and accommodated into six cell accommodating spaces 27.

When a collision load F is input to the electricity storage module 1 mounted on a vehicle (not shown) along the aligning direction of the electricity storage cells 3 (the direction D1), the collision load F acts in a manner that all the electricity storage cells 3 in the cell accommodating body 2 are moved along the input direction of the collision load F (the direction DD.

At this time, when it is assumed that the cell accommodating body is not divided by a partition plate in and only one piece of pressing member is disposed in the center to divide 24 electricity storage cells into two part with 12 electricity storage cells in each part, the electricity storage cell disposed on an input side (right end side in the case of FIG. 5) of the collision load F has the largest moving amount, and the electricity storage cell disposed on the opposite side (left end side in the case of FIG. 5) of the input side of the collision load F receives the load of the other 23 electricity storage cells and is greatly compressed. In this case, if the spring constant of electricity storage cells is set to k, the spring constant of the pressing member is set to h, the input acceleration is set to a, and the mass of the electricity storage cell is set to m, the largest moving amount of the electricity storage cell (the moving amount of the electricity storage cell disposed on the input side of the collision load F) is (23ma+22ma+21ma+ . . . +ma)/k+12ma/h=276ma/k+12ma/h.

In contrast, in the case of this embodiment in which 24 electricity storage cells 3 in the cell accommodating body 2 are dispersed and accommodated into six cell accommodating spaces 27, the moving of the electricity storage cells 3 is limited by five pieces of partition plates 26, and thus the largest moving amount of the electricity storage cell 3 is (3ma+2ma+ma)/k+2ma/h=6ma/k+2ma/h, which is much lower when compared with the aforementioned case. As a result, the load applied to the electrical connection section between the electricity storage cells 3, 3 or the electrical connection section between the electricity storage cells 3 and outside during the acceleration input caused by the collision load F is reduced, and the reliability of the electrical connection of the electricity storage cells 3 can be improved.

Meanwhile, in the cell accommodating body 2, at least any one of a heat sink, a temperature adjustment device or temperature measurement device may be arranged on external side surfaces of the cell accommodating body 2 (external surfaces of the top board 21, the bottom board 22 and the side board 23). Because the cell accommodating body 2 shown in this embodiment improves the heat-transfer performance by being integrally molded by a metal material, the temperature of the wall surface 23a, 26a in the cell accommodating space 27 and of the external side surfaces of the cell accommodating body 2 is equalized. Therefore, the mounting of the temperature adjustment component or the temperature measurement component is easy, and assemblability improvement and cost reduction can be easily achieved.

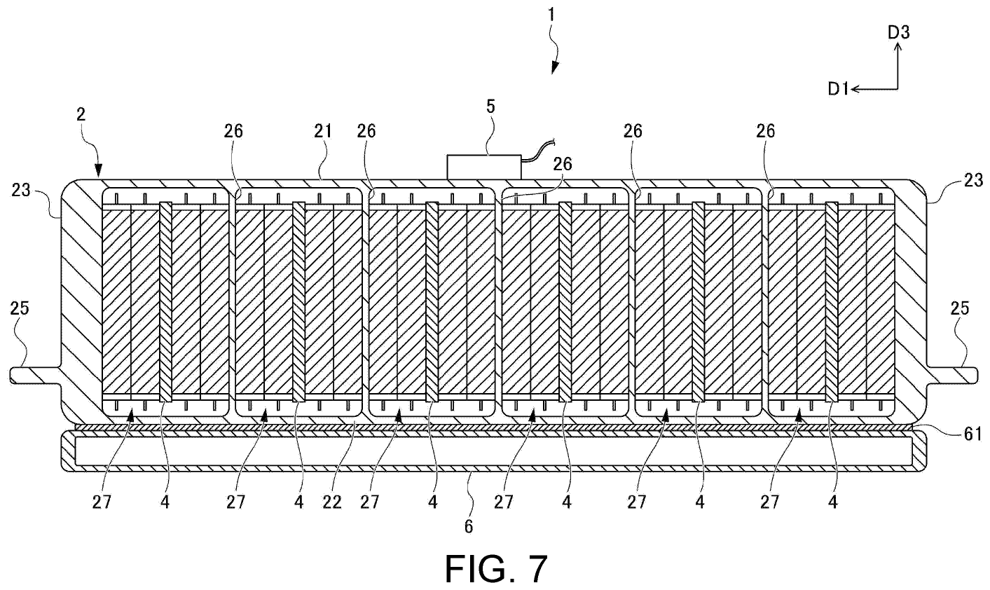

FIG. 7 shows an example in which a temperature sensor 5 serving as a temperature measurement device is arranged on the top board 21 of the cell accommodating body 2 and a water jacket 6 serving as a temperature adjustment device is arranged on the bottom board 22 of the cell accommodating body 2. The water jacket 6 is disposed in contact with the bottom board 22 via a heat-transfer sheet 61. The temperature of the electricity storage cells 3 in each cell accommodating space 27 can be indirectly measured via the top board 21 even with one temperature sensor 5. In addition, the water jacket 6 can efficiently cool the electricity storage cells 3 in each cell accommodating space 27 via the heat-transfer sheet 61 and the bottom board 22.

Next, another embodiment of the electricity storage module of the disclosure is described.

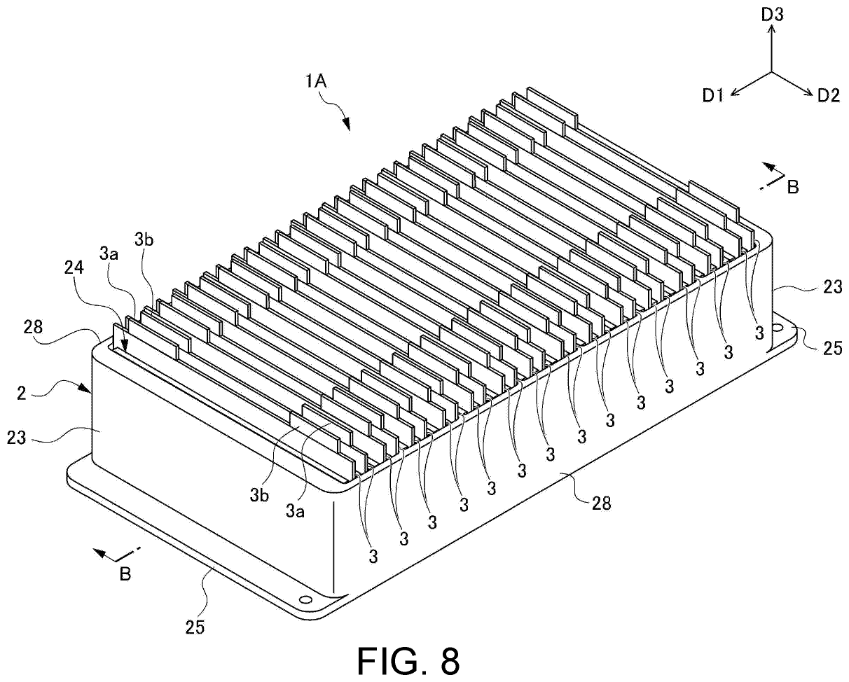

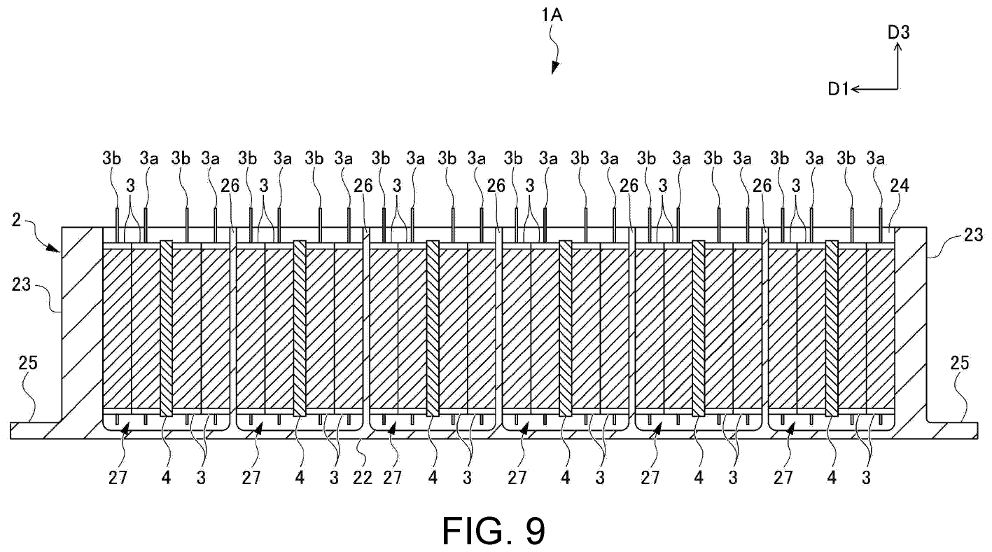

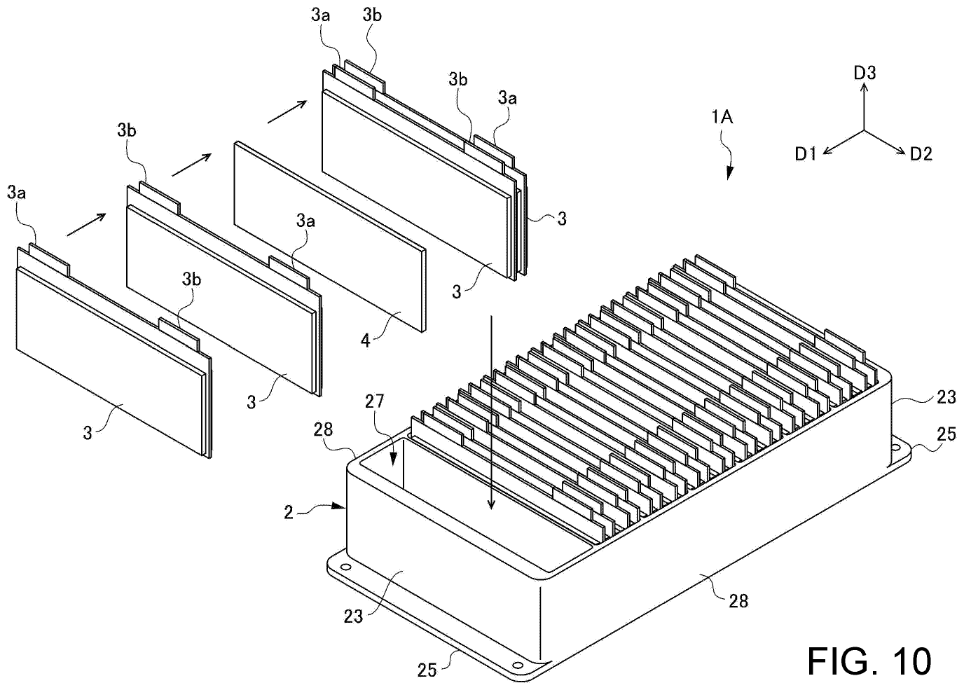

FIG. 8 is a perspective view showing the electricity storage module of another embodiment of the disclosure. FIG. 9 is a cross-section view in which the electricity storage module shown in FIG. 8 is cut off along a B-B line. FIG. 10 is a diagram illustrating a situation that the electricity storage cells are accommodated in the cell accommodating spaces of the electricity storage module shown in FIG. 8. Sections with symbols the same as the symbols in the electricity storage module 1 shown in FIG. 1-FIG. 4 are sections with the same configuration. As for details of these sections, only the configuration different from the aforementioned configuration is described and other description is omitted.

The cell accommodating body 2 shown in this electricity storage module 1A has a shape of so-called bathtub-like box which opens on the top. That is, the cell accommodating body 2 does not have a top board and have a rectangular bottom board 22 being long in the direction D1, side boards 23, 23 on short side being erected from two end portions of the bottom board 22 in the direction D1, side boards 28, 28 on long side being erected from two end portions of the bottom board 22 in the direction D2. Five pieces of partition plates 26 separating the cell accommodating spaces 27 are erected from the bottom board 22 and extend across the two side boards 28, 28 on long side, connecting the two side boards 28, 28.

The electricity storage cells 3 shown in this embodiment are also laminated with the pressing members 4 and four electricity storage cells 3 are accommodated in each cell accommodating space 27. However, positive electrode terminals 3a and negative electrode terminals 3b of the electricity storage cells 3 are disposed apart in the width direction of the electricity storage cells 3 and protrude upward in the same direction. The positive electrode terminal 3a and the negative electrode terminal 3b of each electricity storage cell 3 are electrically connected above the cell accommodating body 2 with a bus bar or a harness which is not shown.

In the electricity storage module 1A, as shown in FIG. 10, except that the electricity storage cells 3 and the pressing members 4 are inserted from above, the electricity storage cells 3 and the pressing member 4 are laminated and accommodated in each cell accommodating space 27 in the same way as in the case of the aforementioned electricity storage module 1. Accordingly, the same effect as the electricity storage module 1 can be obtained.

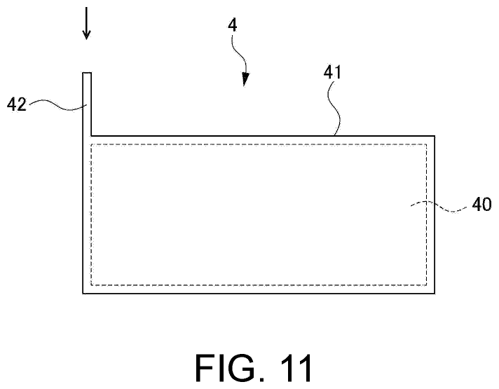

In the electricity storage module 1A, in a case that the pressing member 4 is covered by the resin film 41, as shown in FIG. 11, an injection opening 42 for liquid or gas may be formed integrally with a portion of the resin film 41. By injecting a liquid or gas from the injection opening 42 into the resin film 41, the liquid or gas can be enclosed in the resin film 41. Accordingly, the magnitude to press the electricity storage cells 3 to the wall surfaces 23a, 26a can be easily adjusted by the amount of the liquid or gas enclosed in the resin film 41. Moreover, the injection opening 42 is sealed by an appropriate approach such as welding or the like after the liquid or gas injection.

Water, organic solvents, insulation oil, fluorinated inactive liquids and the like can be used as the liquid injected into the resin film 41. In addition, air, carbon dioxide, nitrogen and the like can be used as the gas.

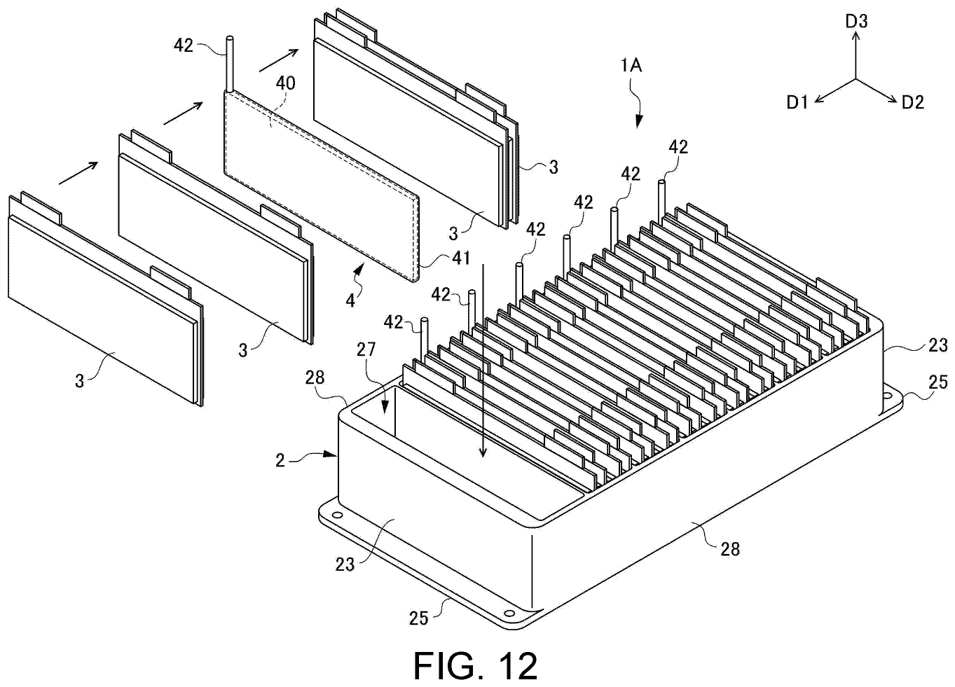

In addition, in a case that the pressing member 4 in which a liquid or gas is injected into the resin film 41 is used in the electricity storage module 1A, as shown in FIG. 12, the pressing member 4 before the injection of liquid or gas may be laminated with the electricity storage cells 3 and accommodated in the cell accommodating space 27, then a predetermined amount of liquid or gas may be injected from the injection opening 42 of each pressing member 4, and thereby the pressing member 4 is made to expand in the cell accommodating space 27. Because the pressing member 4 is in a non-expansion state when the electricity storage cells 3 are accommodated in the cell accommodating space 27, the electricity storage cells 3 can be easily inserted into the cell accommodating space 27 and the assembly is easy. Besides, by appropriately adjusting the timing and amount of injecting the liquid or gas into the resin film 41, the timing to generate the load that presses the electricity storage cells 3 and the magnitude of the load can be easily adjusted in the cell accommodating space 27.

Therefore, the disclosure provides an electricity storage module and a manufacturing method of electricity storage module which are capable of holding a plurality of electricity storage cells without rattling while reducing the moving amount of the electricity storage cells during the acceleration input from the lamination direction of the electricity storage cells and improving the reliability of the electrical connection

According the electricity storage module recited in the aforementioned (1), the plurality of electricity storage cells in the cell accommodating spaces are held without rattling by the pressing member. Besides, the moving amount of the electricity storage cells during the acceleration input from the lamination direction of the electricity storage cells can be reduced by the parallel wall surfaces that separate adjoining cell accommodating spaces. As a result, the electricity storage module that can improve the reliability of the electrical connection of the electricity storage cells can be provided. Furthermore, a contact thermal resistance with the wall surfaces to which the electricity storage cells are pressed decreases and a temperature rise can be suppressed.

(2) In the electricity storage module recited in (1), the pressing member may press the electricity storage cells to the wall surfaces to hold the electricity storage cells by expanding inside the cell accommodating spaces in a thickness direction.

According to the electricity storage module recited in the aforementioned (2), the electricity storage cells are pressed to the wall surfaces by the expansion of the pressing member, and thus the electricity storage cells are reliably held without rattling; meanwhile, the electricity storage cells are not held by adhesion, and thus disassembly is easy and recyclability is improved.

(3) In the electricity storage module recited in (1) or (2), the pressing member may be sandwiched between two electricity storage cells.

According to the electricity storage module recited in the aforementioned (3), the two parallel wall surfaces of the cell accommodating space can be respectively used as a heat transfer surface, and thus the temperature rise of the electricity storage cells can be further suppressed.

(4) In the electricity storage module recited in any one of (1)-(3), the pressing member may be covered by a resin film (for example, a resin film 41 described later).

According to the electricity storage module recited in the aforementioned (4), the pressing member can also be used as an insulator.

(5) In the electricity storage module recited in (4), the electricity storage cells in the cell accommodating spaces may be electrically connected to each other.

According to the electricity storage module recited in the aforementioned (5), the pressing member can be used as an insulator between the electricity storage cells.

(6) In the electricity storage module recited in (4) or (5), the pressing member may have liquid or gas enclosed in the resin film.

According to the electricity storage module recited in the aforementioned (6), the magnitude to press the electricity storage cells to the wall surfaces can be easily adjusted by an amount of the liquid or gas in the resin film.

(7) In the electricity storage module recited in any one of (1)-(6), the pressing member may include an elastic body (for example, an elastic body 40 described later) or a structure having expansibility.

According to the electricity storage module recited in the aforementioned (7), during the expansion of the electricity storage cells, an expansion force of the electricity storage cells can be absorbed by the compression of the elastic body or the structure having swellability, and a load to the wall surfaces or the cell accommodating body during the expansion of the electricity storage cells can be decreased.

(8) In the electricity storage module recited in (7), the elastic body may be a foam body, and the structure may be a swellable resin or a resin fiber aggregate.

According to the electricity storage module recited in the aforementioned (8), weight reduction and cost reduction of the electricity storage module can be achieved.

(9) In the electricity storage module recited in any one of (1)-(8), there may be respective opening portion (for example, an opening portion 24 described later) on two side surfaces of the cell accommodating space, a positive electrode terminal (for example, a positive electrode terminal 3a described later) of the electricity storage cell may be disposed on one of the opening portions, and a negative electrode terminal (for example, a negative electrode terminal 3b described later) of the electricity storage cell may be disposed on the other of the opening portions.

According to the electricity storage module recited in the aforementioned (9), the pressing direction and an electrical extraction direction of the electricity storage cells are different directions, and thus the miniaturization and weight reduction of the cell accommodating body can be achieved and assembly activity is also improved. In addition, the positive electrode terminal and the negative electrode terminal of the electricity storage cell are disposed apart, and thus current distribution of the electricity storage cell is equalized and performance deterioration of the electricity storage cell can be suppressed.

(10) In the electricity storage module recited in any one of (1)-(9), the cell accommodating body may be an integrally molded article in which the wall surfaces and external side surfaces (for example, an external surface of a top board 21, an external surface of a bottom board 22, and an external surface of side boards 23, 28, which are described later) are impact molded or extrusion molded by a metal material.

According to the electricity storage module recited in the aforementioned (10), by integrally molding the cell accommodating body, strength and heat-transfer performance can be improved and a component number can be reduced to save cost.

(11) In the electricity storage module recited in (10), at least any one of a heat sink, a temperature adjustment device (for example, a water jacket 6) described later or a temperature measurement device (for example, a temperature sensor 5 described later) may be disposed on the external side surfaces of the cell accommodating body.

According to the electricity storage module recited in the aforementioned (11), due to the improvement of the heat-transfer performance, temperatures of the wall surfaces of the cell accommodating space and the external side surfaces of the cell accommodating body are equalized, and thus mounting of a temperature adjustment component or a temperature measurement component is easy and assemblability improvement and cost reduction can be easily achieved.

According to the manufacturing method of electricity storage module recited in the aforementioned (12), the plurality of electricity storage cells in the cell accommodating spaces can be reliably held without rattling by the pressing member. Besides, the moving amount of the electricity storage cells during an acceleration input from a lamination direction of the electricity storage cells can be reduced by the parallel wall surfaces which separate adjoining cell accommodating spaces. As a result, the electricity storage module that can improve the reliability of the electrical connection of the electricity storage cells can be manufactured. Furthermore, a contact thermal resistance with the wall surfaces to which the electricity storage cells are pressed decreases and a temperature rise can be suppressed. In addition, there is no need to hold the electricity storage cells by adhesion, and thus disassembly is easy and recyclability is improved.

(13) In the manufacturing method of electricity storage module recited in (12), the pressing member may be accommodated into the cell accommodating spaces in a state of being compressed, and the pressing member may be made to expand in the cell accommodating spaces by a restoring force from the compressed state.

According to the manufacturing method of electricity storage module recited in the aforementioned (13), when the electricity storage cells are accommodated in the cell accommodating spaces, the pressing member is in the compressed state, and thus the electricity storage cells can be easily inserted into the cell accommodating spaces and assembling becomes easy.

(14) In the manufacturing method of electricity storage module recited in (12), the pressing member may be covered by a resin film (for example, a resin film 41 described later), and after the pressing member is accommodated in the cell accommodating space, the pressing member may be made to expand in the cell accommodating space by injecting a liquid or gas into the resin film.

According to the manufacturing method of electricity storage module recited in the aforementioned (14), when the electricity storage cells are accommodated in the cell accommodating spaces, the pressing member is in a non-expansion state, and thus the electricity storage cells can be easily inserted into the cell accommodating spaces and assembling becomes easy. Besides, by adjusting the timing and amount of injecting a liquid or gas into the resin film, the timing to generate the load which presses the electricity storage cells and the magnitude of the load can be easily adjusted in the cell accommodating spaces.

According to the disclosure, an electricity storage module and a manufacturing method of electricity storage module, which are capable of holding a plurality of electricity storage cells without rattling while reducing the moving amount of the electricity storage cells during the acceleration input from the lamination direction of the electricity storage cells and improving the reliability of the electrical connection, can be provided.

What is claimed is:

1. An electricity storage module in which a plurality of electricity storage cells is accommodated in a cell accommodating body, wherein
inside the cell accommodating body, a plurality of cell accommodating spaces having parallel wall surfaces is arranged in a straight line in an aligning direction of the parallel wall surfaces,
in the cell accommodating space, a sheet-like pressing member which gives pressing forces to the electricity storage cells toward the wall surfaces and is accommodated together with the electricity storage cells, and
the electricity storage cells are disposed between the pressing member and the wall surfaces.

2. The electricity storage module according to claim 1, wherein the pressing member presses the electricity storage cells to the wall surfaces by expanding inside the cell accommodating space in a thickness direction.

3. The electricity storage module according to claim 1, wherein the pressing member is sandwiched between two electricity storage cells.

4. The electricity storage module according to claim 1, wherein the pressing member is covered by a resin film.

5. The electricity storage module according to claim 4, wherein the electricity storage cells in the cell accommodating spaces are electrically connected with each other.

6. The electricity storage module according to claim 4, wherein the pressing member has a liquid or gas enclosed in the resin film.

7. The electricity storage module according to claim 1, wherein the pressing member includes an elastic body or a structure having expansibility.

8. The electricity storage module according to claim 7, wherein the elastic body is a foam body, and
the structure is a swellable resin or a resin fiber aggregate.

9. The electricity storage module according to claim 1, wherein there is a respective opening portion on two side surfaces of the cell accommodating space, and
a positive electrode terminal of the electricity storage cell is disposed on one of the opening portions, and a negative electrode terminal is disposed on the other of the opening portions.

10. The electricity storage module according to claim 1, wherein the cell accommodating body is an integrally molded article in which the wall surfaces and external side surfaces are impact molded or extrusion molded by a metal material.

11. The electricity storage module according to claim 10, wherein at least any one of a heat sink, a temperature adjustment device or a temperature measurement device is disposed on the external side surfaces of the cell accommodating body.

12. The electricity storage module according to claim 2, wherein the pressing member is sandwiched between two electricity storage cells.

13. The electricity storage module according to claim 2, wherein the pressing member is covered by a resin film.

14. The electricity storage module according to claim 3, wherein the pressing member is covered by a resin film.

15. The electricity storage module according to claim 12, wherein the pressing member is covered by a resin film.

16. The electricity storage module according to claim 13, wherein the electricity storage cells in the cell accommodating spaces are electrically connected with each other.

17. The electricity storage module according to claim 14, wherein the electricity storage cells in the cell accommodating spaces are electrically connected with each other.

18. A manufacturing method of electricity storage module, which manufactures an electricity storage module in which a plurality of electricity storage cells is accommodated in a cell accommodating body, wherein
inside the cell accommodating body, a plurality of cell accommodating spaces having parallel wall surfaces is arranged in a straight line in an aligning direction of the parallel wall surfaces,
the electricity storage cells and a sheet-like pressing member which gives the electricity storage cells pressing forces toward the wall surfaces are laminated and accommodated in the cell accommodating spaces, and the electricity storage cells are pressed to the wall surfaces by expansion of the pressing member.

19. The manufacturing method of electricity storage module according to claim 18, wherein the pressing member is accommodated in the cell accommodating spaces in a state of being compressed, and the pressing member is made to expand in the cell accommodating spaces by a restoring force from the compressed state.

20. The manufacturing method of electricity storage module according to claim 18, wherein the pressing member is covered by a resin film, and
after the pressing member is accommodated in the cell accommodating space, the pressing member is made to expand in the cell accommodating space by injecting a liquid or a gas into the resin film.
